(19) United States
(12) Patent Application Publication
(10) Pub. No.: US 2024/0220291 A1
(43) Pub. Date: Jul. 4, 2024

(54) INTELLIGENT KNOWLEDGE GRAPH TO FACILITATE USER INPUT INTO GUI FORMS

(71) Applicant: International Business Machines Corporation, Armonk, NY (US)

(72) Inventors: Wei Jun Zheng, Shanghai (CN); Hua Hong Wang, Shanghai (CN); Yuan Jie Song, Shanghai (CN); Min Huang, Shanghai (CN); Qing Lu, Shanghai (CN); Yang Qiu, Shanghai (CN)

(73) Assignee: International Business Machines Corporation, Armonk, NY (US)

(21) Appl. No.: 18/092,299

(22) Filed: Dec. 31, 2022

(51) Int. Cl. G06F 9/451

(52) U.S. Cl. CPC G06F 9/453

(57) ABSTRACT

A method for facilitating user input into a form of a graphical user interface is disclosed. In one embodiment, such a method includes receiving a form implemented on a graphical user interface. The form has multiple fields. The method automatically scans the form to determine relationships such as dependencies between the fields and automatically generates a knowledge graph that describes the fields and their relationships. The fields may be represented as nodes in the knowledge graph. The method enables a user to select a designated field in the form and display the knowledge graph to show relationships between the designated field and other fields in the form. A corresponding system and computer program product are also disclosed.

### BACKGROUND

### Field of the Invention

This invention relates generally to the field of graphical user interfaces, and more particularly to facilitating user input into forms implemented on graphical user interfaces.

### Background of the Invention

Online forms or other graphical-user-interface-based forms are used extensively to input data. For example, a web form, also commonly referred to as an HTML form, is an online page that enables user input and can mimic a paper document or form. Such forms may enable data to be easily and efficiently collected for many different purposes, including collecting information about customers and businesses, gathering information about purchases, or configuring hardware and/or software. In certain cases, different pieces of data that are entered into a form may be related or one piece of data may depend on another piece of data. In such cases, data that is entered into one field of a form may affect or depend on data that is entered into another field of the form. In other cases, a form may require data to be entered using highly technical jargon or terminology or formats that is specific to a particular domain (computer networking, for example). Unless a user is versed in that jargon or terminology, the user may have a very difficult time filling out the form or understanding the dependencies or relationships that may exist between different fields in the form. In some cases, an unsophisticated user may require assistance to correctly fill out a form.

### SUMMARY

The invention has been developed in response to the present state of the art and, in particular, in response to the problems and needs in the art that have not yet been fully solved by currently available systems and methods. Accordingly, systems and methods have been developed to facilitate user input into forms of graphical user interfaces. The features and advantages of the invention will become more fully apparent from the following description and appended claims, or may be learned by practice of the invention as set forth hereinafter.

Consistent with the foregoing, a method for facilitating user input into a form of a graphical user interface is disclosed. In one embodiment, such a method includes receiving a form implemented on a graphical user interface. The form has multiple fields. The method automatically scans the form to determine relationships such as dependencies between the fields and automatically generates a knowledge graph that describes the fields and their relationships. The fields may be represented as nodes in the knowledge graph. The method enables a user to select a designated field in the form and display the knowledge graph to show relationships between the designated field and other fields in the form.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one example of a form having multiple fields;

FIG. 3 is a high-level block diagram showing one embodiment of a knowledge graph that may be displayed when selecting a designated field in a form;

FIG. 4 is a high-level block diagram showing highlighting of selected nodes within the knowledge graph;

FIG. 5 is a high-level block diagram showing presentation of additional information for nodes in a knowledge graph;

FIG. 6 is a high-level block diagram showing presentation of additional information for relationships in a knowledge graph;

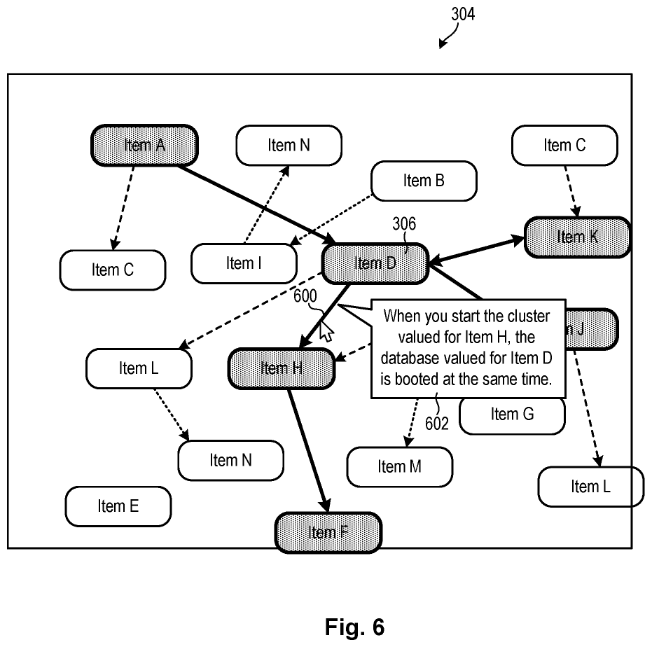

FIG. 7 is a high-level block diagram showing a user input module and associated sub-modules;

FIG. 8 is a table showing keywords that may be generated for a knowledge graph;

FIG. 9 is a table showing context that may be generated for a knowledge graph; and

FIG. 10 is a high-level block diagram showing how a knowledge graph may be generated for a particular form.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “user input module 150”) for facilitating user input into a form of a graphical user interface. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

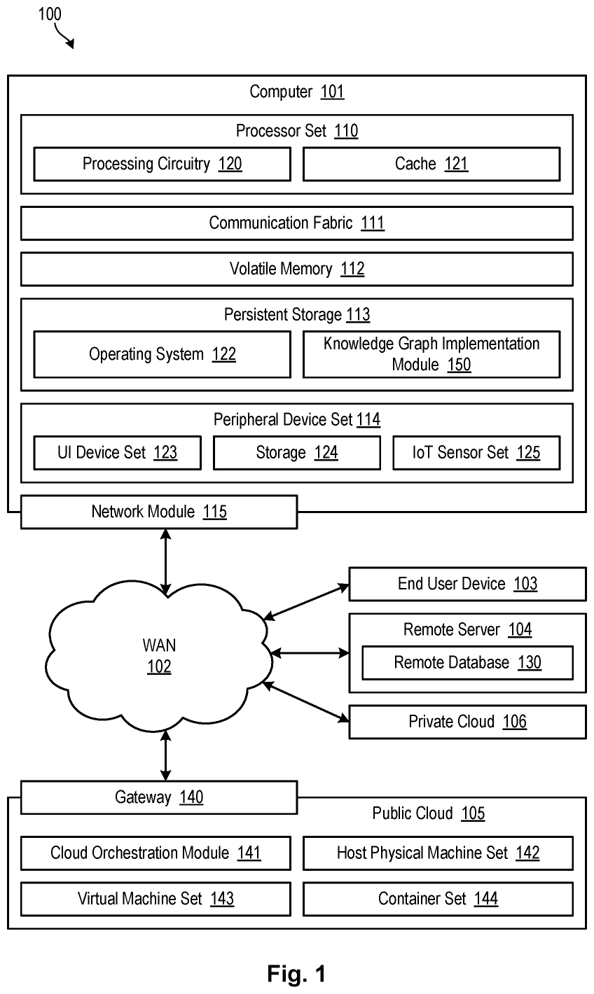

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

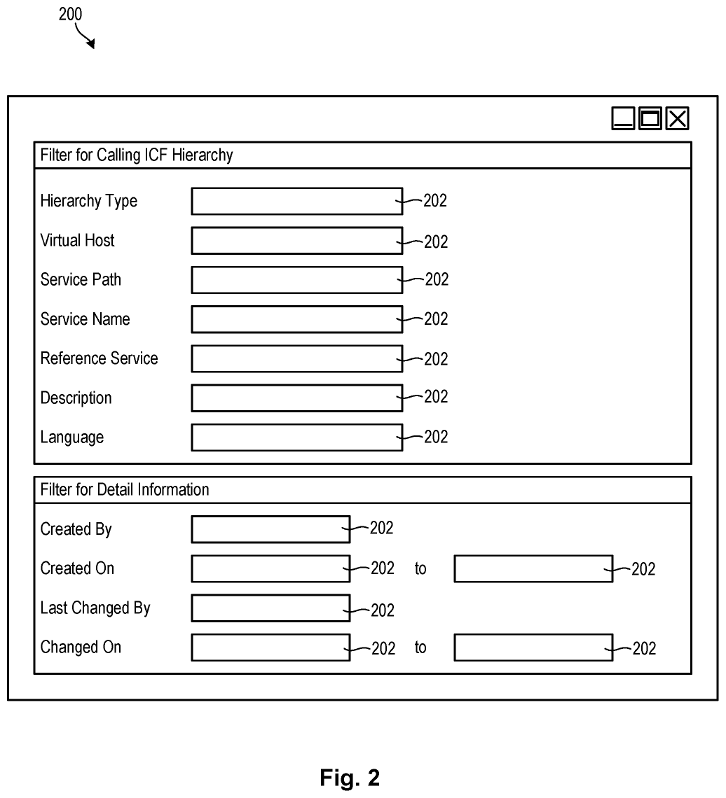

Referring to FIG. 2, as previously mentioned, online forms or other graphical-user-interface-based forms are used extensively to input data. For example, a web form, also commonly referred to as an HTML form, is an online page that enables user input and can mimic a paper document or form. Such forms may enable data to be easily and efficiently collected for many different purposes, including collecting information about customers and businesses, gathering information about purchases, or configuring hardware and/or software. In certain cases, different pieces of data that are entered into a form may be related or one piece of data may depend on another piece of data.

FIG. 2 is a high-level block diagram showing one example of a form 200 having multiple fields 202. In this particular example, data that is entered into one field 202 of the form 200 may affect or depend on data that is entered into another field 202 of the form 200. The form 200 shown in FIG. 2 also uses technical jargon, terminology, and potentially formats that are specific to a particular domain, in this example an Internet Communication Framework (ICF) hierarchy. Unless a user is versed in this jargon or terminology, a user may have a difficult time filling out the form 200 or understanding the dependencies or relationships that may exist between different fields 202 in the form 200. In some cases, an unsophisticated user may require assistance to correctly fill out a form 200 such as that illustrated in FIG. 2.

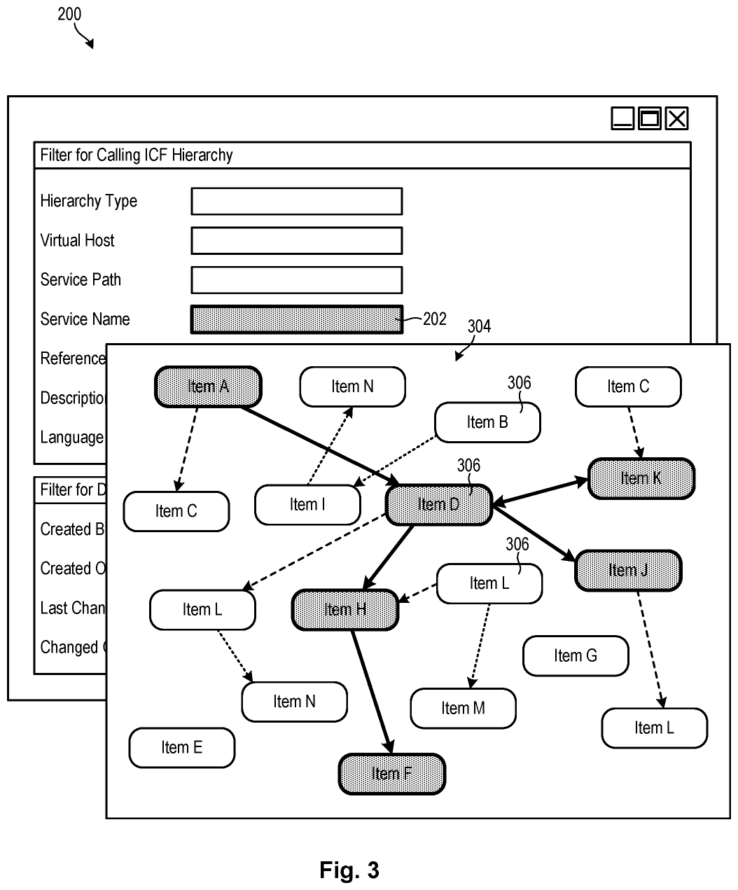

Referring to FIG. 3, in order to assist a user in filling out a form 200, functionality may be provided to inform the user about dependencies or relationships that may exist between different fields 202 in the form 200, as well as inform the user about particular jargon or terminology that may be used in the form 200. In one embodiment, when a user selects a field 202 in the form 200 or performs some other action in association with a field 202 of the form 200, a knowledge graph 304 may be presented to the user that describes the fields 202 and their relationships. In certain embodiments, the knowledge graph 304 may be presented as an overlay (either opaque or semi-transparent) on the form 200 to enable viewing of the knowledge graph 304 along with the form 200.

In certain embodiments, the fields 202 may be represented as nodes 306 in the knowledge graph 304 and the relationships or dependencies may be represented as lines between the nodes 306. In certain embodiments, as shown in FIG. 3, a node 306 that represents a selected field 202 may be highlighted in the knowledge graph 304. Other nodes 306 (i.e., fields 202) that are related to the highlighted node 306 may also optionally be highlighted. In certain embodiments, the lines that connect the highlighted nodes 306 may also be highlighted.

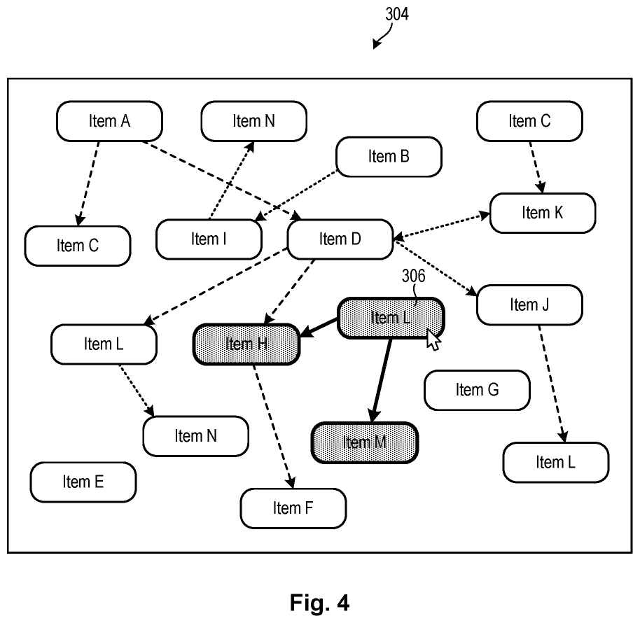

Referring to FIG. 4, in certain embodiments, a user may change the nodes 306 that are highlighted in the knowledge graph 304. For example, as shown in FIG. 4, selecting a different node 306 in the knowledge graph 304 may highlight the selected node 306 and potentially other related nodes 306 and the lines that connect the nodes 306.

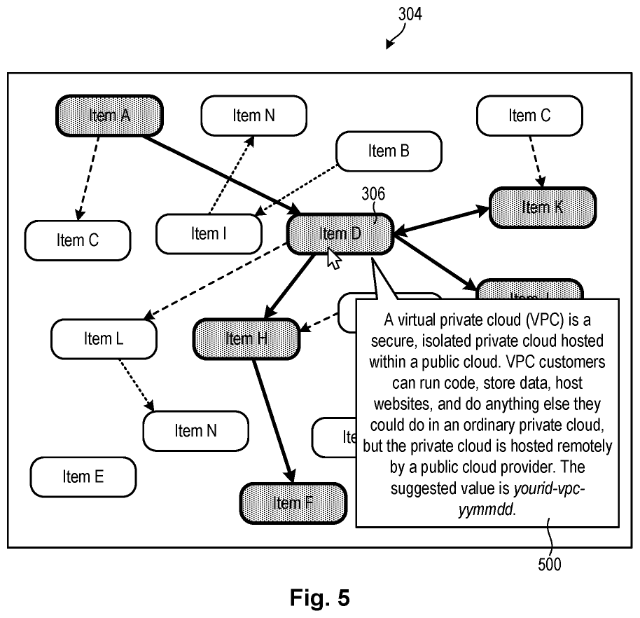

Referring to FIG. 5, in other or the same embodiments, the knowledge graph 304 may be used to present additional information and/or context about a node 306 or field 202. For example, in certain embodiments, hovering over or selecting a node 306 (e.g., with a mouse pointer or cursor) in the knowledge graph 304 may cause a text box 500 or other descriptive element to appear that describes a node 306 or field 202. In certain embodiments, a default or suggested value for the node 306 or field 202 may be presented. Similarly, in certain embodiments, hovering over or selecting a relationship 600 or dependency 600 (i.e., line 600) in the knowledge graph 304 may cause a text box 602 or other descriptive element to appear that describes the relationship 600 or dependency 600. In certain embodiments, text in a text box 500, 602 may be further defined or explained (such as with additional text boxes) if a user selects or hovers over certain terms or phrases in the text box 500, 602.

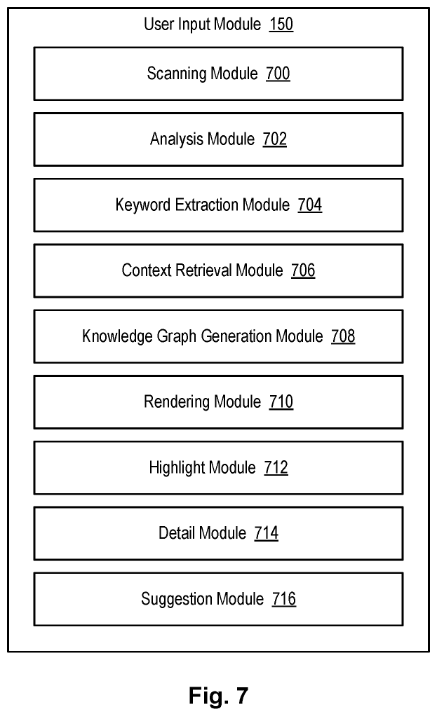

Referring to FIG. 7, one embodiment of a user input module 150 in accordance with the invention is illustrated. The user input module 150 is shown along with various associated sub-modules that may be provided to perform various features and functions. These modules may be implemented in hardware, software, firmware, or combinations thereof. These modules are presented by way of example and not limitation. More or fewer modules may be provided in different embodiments. For example, the functionality of some modules may be combined into a single or smaller number of modules, or the functionality of a single module may be distributed across several modules.

As shown, in certain embodiments, the user input module 150 may include one or more of a scanning module 700, analysis module 702, keyword extraction module 704, context extraction module 706, knowledge graph generation module 708, rendering module 710, highlight module 712, detail module 714, and suggestion module 716.

The scanning module 700 may be used to scan a form 200 to determine input fields 202 in the form 200 as well as any referenced pages. The analysis module 702 may analyze a user profile of a form 200, the scanned content of the form 200, the tasks on the form 200, and the context associated with the fields 202 of the form 200. In general, the analysis module 702 may analyze form content (e.g., documents, images, etc.) to determine the relationships or dependencies between fields 202, as well as the context associated with the fields 202 and their relationships or dependencies. The keyword extraction module 704 may be configured to extract keywords for the fields 202 in a form 200. The keywords may include possible terms or phrases that may be entered into each field 202 of the form 200. The context extraction module 706, by contrast, may be configured to extract or generate context for the fields 202 or keywords of a form 200.

Using the keywords and the context, the knowledge graph generation module 708 may be configured to generate the knowledge graph 304 previously discussed. The rendering module 710 may render the knowledge graph 304 to facilitate the visual presentation of the knowledge graph 304. In certain embodiments, the knowledge graph 304 is rendered dynamically after a form 200 is loaded and/or a user clicks on or selects any field 202 in the form 200, or types or enters a keyword into the form 200. In certain embodiments, the knowledge graph 304 is rendered in a waterfall or matrix style.

The highlight module 712 may be configured to highlight particular nodes 306 or relationships 600 in the knowledge graph 304. In certain embodiments, this may include highlighting a particular node 306 or field 202 in the knowledge graph 304 that has been selected by a user. This may also include highlighting nodes 306 or fields 202 that are related to or depend on the selected node 306 or field 202. If another node 306 is selected in the knowledge graph 304, the highlight module 712 may highlight the newly selected node 306 and potentially nodes 306 or fields 202 that are related to the selected node 306. Highlighting may include emphasizing, between highlighted nodes 306, lines 600 that represent relationships 600 or dependencies 600 between the highlighted nodes 306.

The detail module 714 may include functionality to present additional information and/or context about a node 306 or field 202. As previously explained, in certain embodiments, hovering over or selecting a node 306 in the knowledge graph 304 with a mouse pointer or cursor may cause a text box 500 or other descriptive element to pop up that describes a node 306 or field 202. In certain embodiments, a default or suggested value for the node 306 or field 202 may be presented. In a similar manner, hovering over or selecting a relationship 600 or dependency 600 (i.e., line 600) in the knowledge graph 304 may cause a text box 602 or other descriptive element to appear that describes the relationship 600 or dependency 600. In certain embodiments, the user may be able to drill down further by selecting or hovering over certain terms or phrases in the text boxes 500, 602 to reveal additional information or provide further explanation.

The suggestion module 716 may suggest, to a user, values to enter into fields 202 of the form 200. In certain embodiments, these values may be default values. In other embodiments, these values may be those most often or frequently selected, or values that have historically achieved the best results. In certain embodiments, these values may be entered into a field 202 with a single click or selection. In yet other embodiments, the suggestions may be based on values entered into other fields 202 of the form 200. For example, where a field 202 has a relationship or dependency with another field 202 in the form 200, a suggested value for the field 202 may depend on a value entered into the other field 202. In certain embodiments, the suggestion module 716 may prevent certain terms or phrases from being entered into a field 202 such as in instances where values in two different related fields 202 are incompatible with one another.

The user input module 150 and associated sub-modules may, in certain embodiments, be implemented as a browser plugin or a library used for a web application. It is contemplated that the browser plugin or library could be operated in two different modes: (1) a loosely coupled mode wherein a web application doesn't need to be changed but can run the plug-in or library to scan a current form 200 (e.g., web page) and generate a knowledge graph 304 in association with the form 200; and (2) a more tightly coupled mode wherein a web application integrates the browser plugin or library and provides context and relationships for each input field 202 (e.g., required vs. optional, default, 1:N, etc.) or defines the context and relationships in a file or repository. In certain embodiments, the more tightly coupled mode may provide a more accurate and helpful knowledge graph 304 for a user.

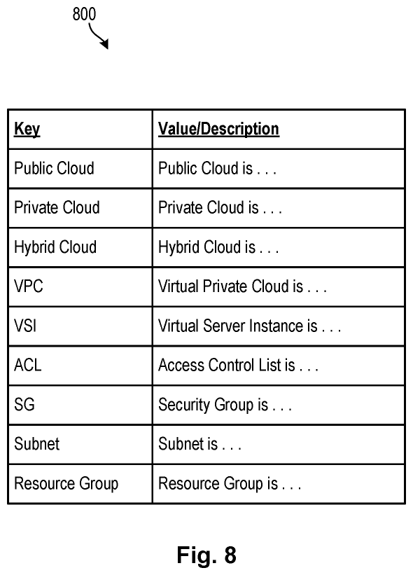

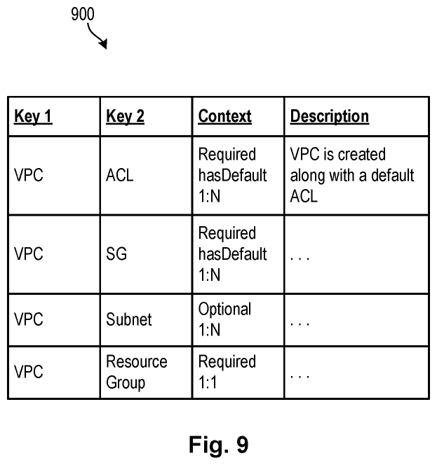

Referring to FIGS. 8 and 9, tables 800, 900 are presented showing examples of extracted keywords and context for a form 200. Such keywords and context may be extracted from the contents of web applications, or from pre-defined files or repositories. For each keyword collected from a form 200, a key and description may be recorded, as shown in FIG. 8. FIG. 9 is a context table that shows relationships and dependencies between various keywords. For example, for the keyword “VPC,” the value for “ACL” is required, which means that filling in a value for ACL is a prerequisite for the field 202 “VPC” to take effect. If no value is provided for ACL, a default value may be used.

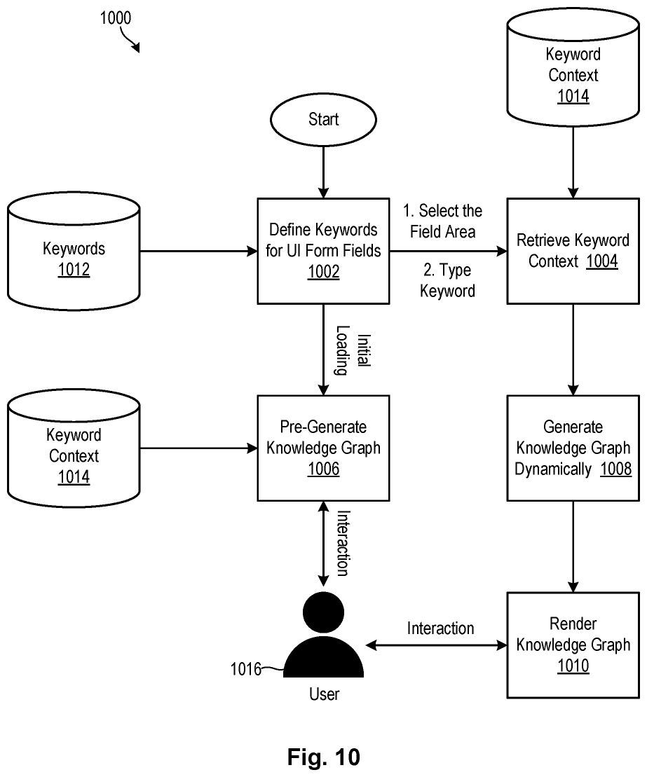

Referring to FIG. 10, a high-level block diagram is presented that shows how a knowledge graph 304 is generated for a particular form 200. As shown, the method 1000 initially defines 1002 keywords for the user-interface form fields 202. The method 1000 may then optionally follow two different paths. First, the method 1000 may pre-generate 1006 a knowledge graph 304 using keywords 1012 and keyword context 1014. Alternatively, when a user selects a field 202 and/or types a keyword into a field 202 of a form 200, the method 1000 may retrieve 1004 keyword context 1014 and generate 1008 a knowledge graph 304 dynamically. The method 1000 may then render 1010 the knowledge graph 304. The method 1000 may enable interaction between a user and the knowledge graph 304.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method comprising:
receiving a form implemented on a graphical user interface, the form comprising a plurality of fields;
automatically scanning the form to determine relationships between the fields;
automatically generating a knowledge graph that describes the fields and the relationships;
enabling a user to select a designated field in the form;
visually displaying, to the user, the knowledge graph to show how the designated field relates to the fields and the relationships in the form, wherein visually displaying the knowledge graph comprises visually displaying the fields as nodes and the relationships as lines between the nodes, and wherein visually displaying the knowledge graph comprises overlaying the knowledge graph onto the form;
displaying, in response to hovering a curser over a first node in the knowledge graph, a text box comprising additional information about the first node; and
displaying, in response to hovering the curser over a term within the text box, a subset of additional information about the first node.

2. The method of claim 1, further comprising highlighting, within the knowledge graph in response to the selection, a particular node associated with the designated field.

3. The method of claim 2, further comprising highlighting, within the knowledge graph in response to the selection, other nodes and the lines that are related to the particular node.

4. (canceled)

5. (canceled)

6. The method of claim 1, wherein hovering over the lines causes additional information to be presented about the relationships.

7. The method of claim 1, wherein the relationships comprise dependencies between the fields.

8. A computer program product comprising a computer-readable storage medium having computer-usable program code embodied therein, the computer-usable program code configured to perform the following when executed by at least one processor:
receive a form implemented on a graphical user interface, the form comprising a plurality of fields;
automatically scan the form to determine relationships between the fields;
automatically generate a knowledge graph that describes the fields and the relationships;
enable a user to select a designated field in the form;
visually display, to the user, the knowledge graph to show how the designated field relates to the fields and the relationships in the form, wherein visually displaying the knowledge graph comprises visually displaying the fields as nodes and the relationships as lines between the nodes, and wherein visually displaying the knowledge graph comprises overlaying the knowledge graph onto the form;
display, in response to hovering a curser over a first node in the knowledge graph, a text box comprising additional information about the first node; and
display, in response to hovering the curser over a term within the text box, a subset of additional information about the first node.

9. The computer program product of claim 8, wherein the computer-usable program code is further configured to highlight, within the knowledge graph in response to the selection, a particular node associated with the designated field.

10. The computer program product of claim 9, wherein the computer-usable program code is further configured to highlight, within the knowledge graph in response to the selection, other nodes and the lines that are related to the particular node.

11. (canceled)

12. (canceled)

13. The computer program product of claim 8, wherein hovering over the lines causes additional information to be presented about the relationships.

14. The computer program product of claim 8, wherein the relationships comprise dependencies between the fields.

15. A system comprising:
at least one processor;
at least one memory device operably coupled to the at least one processor and storing instructions for execution on the at least one processor, the instructions causing the at least one processor to:
receive a form implemented on a graphical user interface, the form comprising a plurality of fields;
automatically scan the form to determine relationships between the fields;
automatically generate a knowledge graph that describes the fields and the relationships;
enable a user to select a designated field in the form;
visually display, to the user, the knowledge graph to show how the designated field relates to the fields and the relationships in the form, wherein visually displaying the knowledge graph comprises visually displaying the fields as nodes and the relationships as lines between the nodes, and wherein visually displaying the knowledge graph comprises overlaying the knowledge graph onto the form;
display, in response to hovering a curser over a first node in the knowledge graph, a text box comprising additional information about the first node; and
display, in response to hovering the curser over a term within the text box, a subset of additional information about the first node.

16. The system of claim 15, wherein the instructions further cause the at least one processor to highlight, within the knowledge graph in response to the selection, a particular node associated with the designated field.

17. The system of claim 16, wherein the instructions further cause the at least one processor to highlight, within the knowledge graph in response to the selection, other nodes and the lines that are related to the particular node.

18. (canceled)

19. (canceled)

20. The system of claim 15, wherein hovering over the lines causes additional information to be presented about the relationships.

21. The method of claim 1, wherein the additional information and/or the subset of additional information includes one or more suggested values to enter into an associated field of the first node.

22. The method of claim 21, wherein the one or more suggested values may be entered into the form with a single selection.

23. The method of claim 21, wherein the one or more suggested values are based on historically selected values.

24. The method of claim 21, wherein the one or more suggested values are based on a dependency to a first value entered into another field on the form.

25. The method of claim 1, wherein the knowledge graph is dynamically displayed to the user in response to a keyword entered into at least one field of the plurality of fields of the form.
